(19) United States
(12) Patent Application Publication
(10) Pub. No.: US 2006/0121950 A1
(43) Pub. Date: Jun. 8, 2006

(54) Wireless handfree headset device for a helmet

(76) Inventor: Chi-Cheng Lee, Taipei County (TW)

Correspondence Address: Chi-Cheng Lee, P.O. Box No. 6-57, Junghe, Taipei, 235 R.O.C., TW

(21) Appl. No.: 11/003,345

(22) Filed: Dec. 6, 2004

(51) Int. Cl. H04M 1/00

(52) U.S. Cl. 455/569.1; 455/575.2

(57) ABSTRACT

A communication device includes a first low frequency transmission/receiver module and a second low frequency transmission/receiver module configured on a helmet and a portable communication device respectively. A sounder device and a receiver device are configured on the helmet so as to correspond to position of the ear and the mouth of a wearer of the helmet respectively, and which are mutually connected to the first low frequency transmission/receiver module. Wireless transmission signals between the second low frequency transmission/receiver module of the portable communication device and the first low frequency transmission/receiver module configurationally connected to the sounder device and the receiver device of the helmet thereby enable the wearer of the helmet to directly utilize the receiver device and the sounder device of the helmet to carry out a conversation with an incoming caller.

### BACKGROUND OF THE INVENTION

(a) Field of the Invention

The present invention relates to a wireless handfree headset device for application in a safety helmet, a work helmet, a police helmet, a cap, and so on, and more particularly to providing a device that does not require suspending of multifarious wiring, while immediately enabling a wearer to directly utilize a receiver device and a sounder device of the helmet to carry out voice transmission with an incoming caller.

(b) Description of the Prior Art

Thus far development in mobile communication technologies has already achieved almost universality in usage, with a cellular phone in practically every hand. Hence, such a mode of convenient mobile communication has not only reenforced facilitation in distant communication, moreover, has evidently transformed contact and information transmission between persons. Furthermore, because the cellular phone pertains to a portable communication device that is extremely light and handy (wireless communication devices also pertain to portable communication equipment), thus communicating with another person is relatively seldom restricted by time, motion or location.

Furthermore, such portable communication devices like the cellular phone, apart from providing enhancement in telecommunication quality and functionality, moreover, development is gradually progressing towards reducing weight and miniaturization of the portable communication devices,

Even though manufacturing technology has already achieved considerable reduction in size of portable communication devices, however, based on consideration of convenient operation, handheld models of portable communication devices necessarily embody a configuration that effectuates favorable operation. Thus, during actual usage, a general user still habitually employs a handheld mode as a means to utilize the portable communication device for communicating.

In addition, a general rider of a motorcycle or driver of an automobile, under legal provisions of road safety the handheld mode cellular phone can not be utilized for communication purposes while riding the motorcycle or. driving the car. Hence, majority of motorcycle riders or automobile drivers use handfree headset devices having earphones and a microphone connected to the cellular phone, which allows implementing communication without either of the hands having to hold the cellular phone.

According to the aforementioned, the handfree headset device having a structured that comprises the earphones and the microphone apparently embodies a simple structural characteristic. However, because the handfree headset device necessarily requires suspending signal wires from the earphones and microphone during usage, and only then can the earphones and the microphone be disposed at locations for preferred sound transmission and sound reception, which thus causes great inconvenience in usage. More particularly, when the user is wearing a helmet, because slight swaying of the helmet often results in loosening of the earphones or causes inappropriate constriction, which forces the wearer to take off the helmet, whereafter adjustment of the earphones can be carried out, which not only causes great inconvenience in usage, and correspondingly, because the two hands of the motorcycle rider must firmly grip handles of the motorcycle, further inconvenience results. Furthermore, directly adjusting the wires or position of the earphones prior to the motorcycle coming to a halt will affect motorcycle-riding safety.

Analogous circumstances can be seen in other personage working at construction sites or factories who must grip hand tools or operate machinery with both hands. Even soldiers and police personnel on duty, who while carrying out designated duties necessarily further utilize wireless portable communication devices as a long-distance communication tool, and, moreover, necessarily wear the helmet as basic protection or as identification of status. Hence, similar to the aforementioned, because of inconvenience resulting from difficulty in securing the earphones, microphone and wiring of the conventional handheld device, danger in executing designated duties may result.

### SUMMARY OF THE INVENTION

A wireless handfree headset device for a helmet of the present invention primarily comprises a first low frequency transmission / receiver module configured on a helmet, a sounder device configured on the helmet so as to correspond to position of the ear of a wearer of the helmet, which is mutually connected to the first low frequency transmission/receiver module, and a receiver device configured on the helmet so as to correspond to position of the mouth of the wearer of the helmet, which is mutually connected to the first low frequency transmission/receiver module. In addition, a portable communication device carried by a user is integrated with a second low frequency transmission/receiver module, thereby wireless transmission signals between the second low frequency transmission/receiver module of the portable communication device and the first low frequency transmission/receiver module configurationally connected to the sounder device and the receiver device of the helmet facilitates the wearer of the helmet to directly utilize the receiver device and the sounder device of the helmet to carry out a conversation with an incoming caller.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic structural view of a first embodiment of a handfree headset device according to the present invention.

FIG. 2 shows a schematic structural view of a second embodiment of a handfree headset device according to the present invention.

FIG. 3 shows a schematic structural view of a third embodiment of a handfree headset device according to the present invention.

FIG. 4 shows a schematic structural view of a fourth embodiment of a handfree headset device according to the present invention.

FIG. 5 shows a schematic structural view of a fifth embodiment of a handfree headset device according to the present invention.

### DETAILED DESCRIPTION OF THE PREFERRED EMBODIMENTS

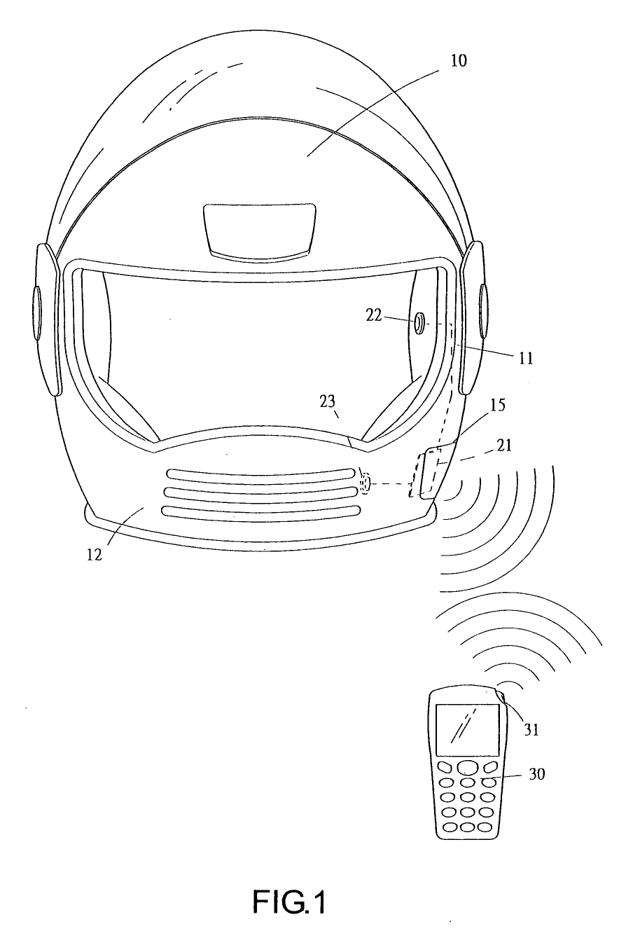

Referring to FIG. 1, which depicts a basic structural configuration of an embodiment of a wireless handfree headset device for a helmet of the present invention, wherein a first low frequency transmission/receiver module 21 is configured on a helmet 10, and dry batteries are utilized to actuate operation of the first low frequency transmission/receiver module 21 (not shown in the FIGS). A battery magazine 15 is configured on the helmet 10, and is utilized to dispose the dry batteries therein. Electric power from the dry batteries is utilized to actuate the first low frequency transmission/receiver module 21. Solar batteries can be also complementarily configured on the helmet 10 (not shown in the FIGS. ), thereby directly utilizing solar energy to actuate the first low frequency transmission/receiver module 21 therewith.

Furthermore, a sounder device 22 is configured on the helmet 10 so as to correspond to position of the ear of a wearer of the helmet 10, and which is mutually connected to the first low frequency transmission/receiver module 21. A receiver device 23 is configured on the helmet 10 so as to correspond to position of the mouth of the wearer of the helmet 10, and which is mutually connected to the first low frequency transmission/receiver module 21. In regard to a portable communication device 30 carried by a user, the portable communication device 30 is integrated with a second low frequency transmission/receiver module 31, and which is directly actuated by means of electric power supplied by batteries disposed in the portable communication device 30. Accordingly, when the user carrying the portable communication device 30, such as a cellular phone or a wireless communication device, and so on, receives an incoming call, wireless transmission signals between the second low frequency transmission/receiver module 31 of the portable communication device 30 and the first low frequency transmission/receiver module 21 configurationally connected to the sounder device 22 and the receiver device 23 of the helmet 10 thereby enable the wearer of the helmet 10 to directly utilize the receiver device 23 and the sounder device 22 of the helmet 10 to carry out a conversation with an incoming caller.

Referring to the embodiment as shown in FIG. 1, which depicts a full face safety helmet type having two cheek covering members 11 and a lower jaw covering member 12 configured on the helmet 10, wherewith enables directly configuring the sounder device 22 on an inner side position of the two cheek covering members 11 of the helmet 10. Furthermore, the receiver device 23 can thus be directly configured on an inner side position of the lower jaw covering member 12 of the helmet 10, which thereby effectuates integrating with the helmet 10, and moreover, superior effectiveness in reception and transmission is acquired. More particularly, such a configuration eliminates actions required to suspend wiring between the sounder device 22 and the receiver device 23 during actual usage, which not only provides the present invention with convenience of usage, moreover, prevents the sounder device 22 and the receiver device 23 from haphazardly falling off.

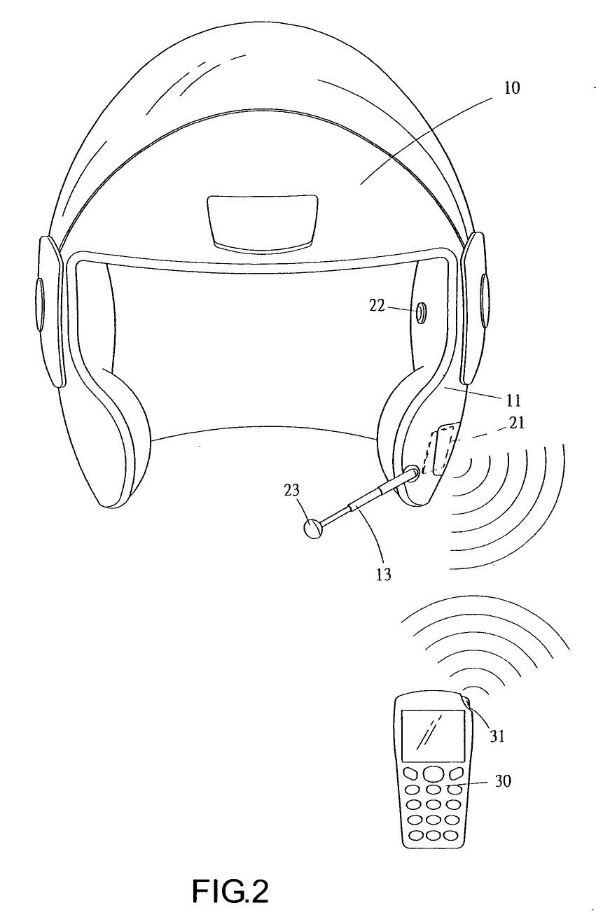

Furthermore, when the helmet 10 assumes a type of an open face safety helmet as depicted in FIG. 2, because the open face safety helmet 10 is only provided with the two cheek covering members 11, thus, an extended telescopic rod 13 can be configured on one of the two cheek covering members 11 so as to face towards the lower jaw portion, moreover, the sounder device 22 can be configured on the inner side portion of the two cheek covering members 11 of the helmet 10, while the receiver device 23 is configured on an end extremity of the telescopic rod 13. Sound reception and transmission acquired by such a configuration is of analogous superior quality.

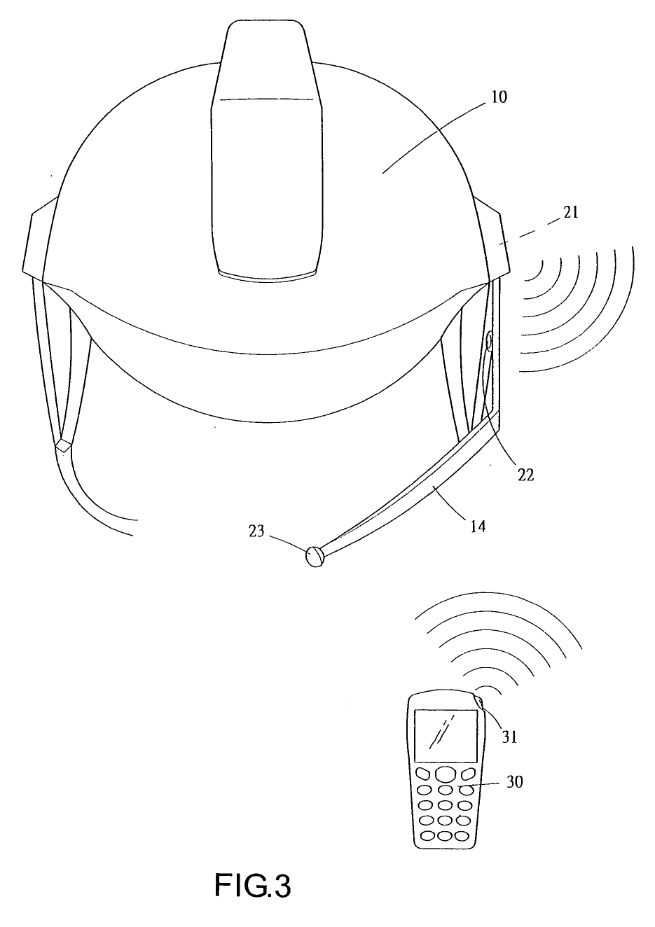

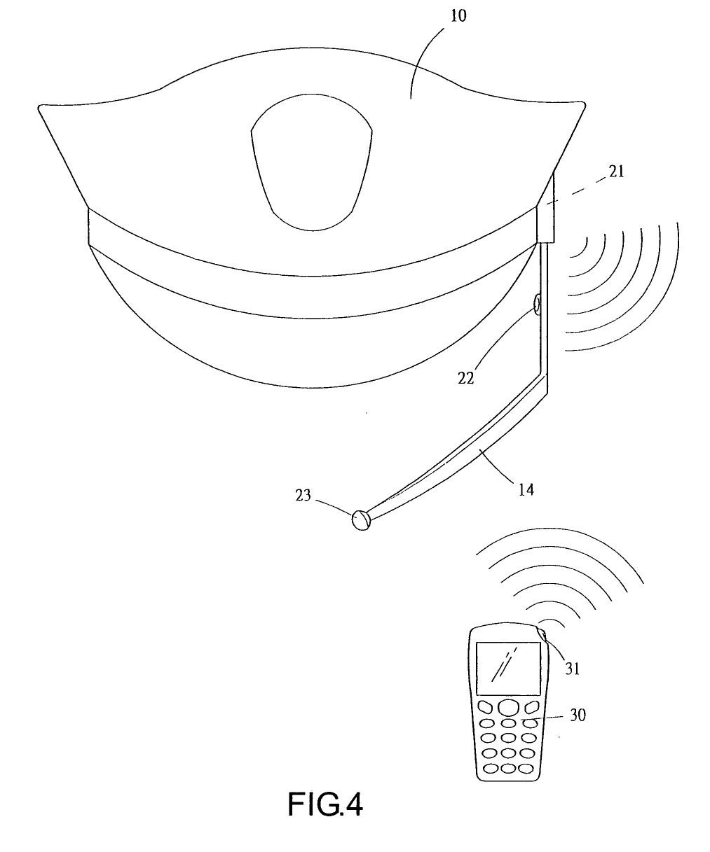

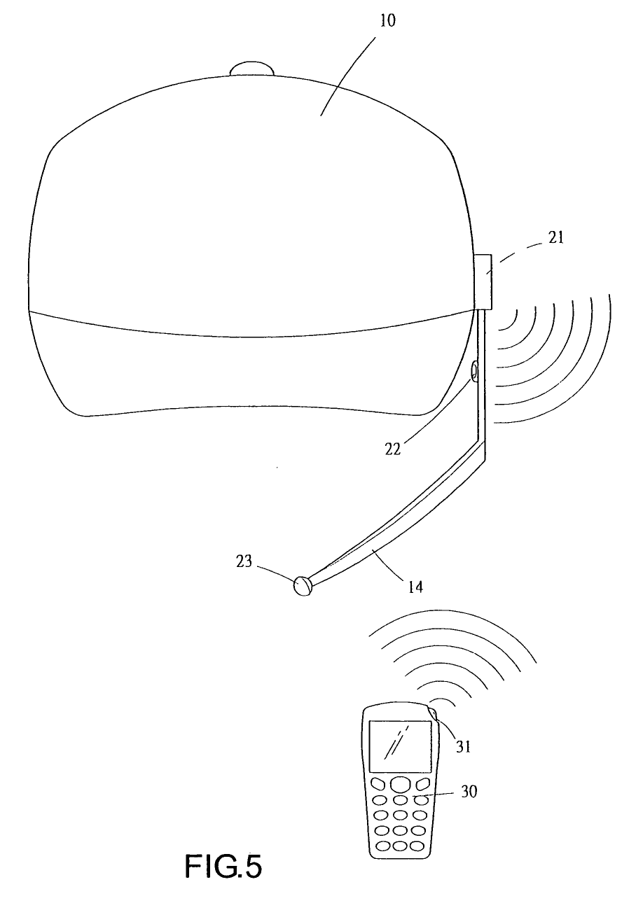

In addition, referring to FIGS. 3, 4 and 5, which show schematic views of the present invention applied in a work helmet, a police helmet and a cap respectively, wherein the helmet 10 is structured without provision of two cheek covering members or a lower law covering member. Because the helmet 10 is not configured with the cheek covering members nor with the lower jaw covering member, thus, a support 14 can be configured on the helmet 10 so as to correspond to a side of the head portion of the wearer, and which can be adjustably extended in multistage directions to face towards the ear and lower jaw of the wearer of the helmet 10. The support 14 can be folded to the helmet 10 or dismantled from the helmet 10. The sounder device 22 is configured on the support 14 so as to correspond to position of the ear of the wearer, and the receiver device 23 is configured on the support 14 so as to correspond to position of the lower jaw of the wearer, thereby maintaining expected quality of sound reception and transmission, and convenience of usage.

According to the aforementioned, the present invention provides the safety helmet, the work helmet, the police helmet, the cap, and so on, with a superior portable wireless handfree headset device. It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A wireless handfree headset device for a helmet, comprising a first low frequency transmission/receiver module configured on a helmet, batteries utilized to actuate operation of the first low frequency transmission/receiver module, a sounder device configured on the helmet so as to correspond to position of the ear of a wearer of the helmet, which is mutually connected to the first low frequency transmission/receiver module, and a receiver device configured on the helmet so as to correspond to position of the mouth of the wearer of the helmet, which is mutually connected to the first low frequency transmission/receiver module; in addition, a portable communication device carried by a user is integrated with a second low frequency transmission/receiver module, thereby wireless transmission signals between the second low frequency transmission/receiver module of the portable communication device and the first low frequency transmission/receiver module configurationally connected to the sounder device and the receiver device of the helmet enable the wearer of the helmet to directly utilize the receiver device and the sounder device of the helmet to carry out a conversation with an incoming caller.

2. The wireless handfree headset device for a helmet according to claim 1, wherein two cheek covering members and a lower jaw covering member are configured on the helmet, and the sounder device is configured on an inner side position of the two cheek covering members of the helmet, and the receiver device is configured on an inner side position of the lower jaw covering member of the helmet.

3. The wireless handfree headset device for a helmet according to claim 1, wherein the two cheek covering members and the lower jaw covering member are configured on the helmet, an extended telescopic rod is configured on one of the two cheek covering members so as to face towards the lower jaw portion, moreover, the sounder device is configured on the inner side portion of the two cheek covering members of the helmet, while the receiver device is configured on an end extremity of the telescopic rod.

4. The wireless handfree headset device for a helmet according to claim 1, wherein a support is configured on the helmet so as to correspond to a side of the head portion of the wearer, and which can be adjustably extended in multistage directions to face towards the ear and lower jaw of the wearer of the helmet, moreover, the sounder device is configured on the support so as to correspond to position of the ear of the wearer, and the receiver device is configured on the support so as to correspond to position of the lower jaw of the wearer.

5. The wireless handfree headset device for a helmet according to claim 1, wherein a battery magazine is configured on the helmet, and is utilized to dispose the batteries therein.

6. The wireless handfree headset device for a helmet according to claim 1, wherein the batteries utilized are solar energy batteries.
